(19) United States
(12) Patent Application Publication
(10) Pub. No.: US 2002/0046402 A1
(43) Pub. Date: Apr. 18, 2002

(54) Application server delivery of information to customers from multiple sources

(76) Inventors: Olalekan Akinyanmi, Canyon Country, CA (US); John Hervey, Bradbury, CA (US)

Correspondence Address: David A. Hall, Heller Ehrman White & McAuliffe LLP, 6th Floor, 4350 La Jolla Village Drive, San Diego, CA, 92122-1246, US

(21) Appl. No.: 09/892,013

(22) Filed: Jun. 25, 2001

Related U.S. Application Data
(60) Provisional application No. 60/241,114, filed on Oct. 16, 2000.

(51) Int. Cl. H04N 7/025; H04N 7/10; G06F 3/00; H04N 5/445; G06F 13/00

(52) U.S. Cl. 725/34; 725/35; 725/46

(57) ABSTRACT

Information from multiple sources is provided to customers, wherein multiple channels of content are received at a service headend connection for customer viewing, information is received from the customer relating to customer viewing, and a selected channel of content likely to be of interest to the customer is determined, based on the received customer viewing information. Information about the selected channel is automatically provided to the customer. A client delivery agent at a customer location is responsible for monitoring and collecting information relating to customer viewing of content from among the multiple channels of content that are available. The collected customer viewing information is periodically uploaded to the headend connection, where it is accumulated in a database and is analyzed for channels of content likely to be of interest.

### REFERENCE TO PRIORITY DOCUMENT

This application claims the benefit of U.S. Provisional Application No. 60/214,114, filed Jun. 26, 2000.

### BACKGROUND OF THE INVENTION

1. Field of the Invention

This invention relates generally to network delivery of content and, more particularly, to selection of content from among multiple channels of content.

2. Description of the Related Art

A great amount of information is available to consumers today, from a wide variety of content sources. The content includes radio programming, television video programming from sources such as broadcast television networks and cable television networks, Internet content such as pages of information from the “World Wide Web”, and databases from other networks, including proprietary networks. Each one of these types of information content typically comes from a different provider and is often provided to customers from a source provider, who is also called a multi-service operator (MSO). Each one of these types of information often requires a different type of device to listen to, view, or otherwise observe the information.

For example, radio programming is usually listened to with a radio receiver, whereas broadcast television programming and cable television programming is viewed with a television. Internet information may be viewed through an appropriate browser application, either through a computer or a wireless telephone or other Internet compatible communications device. Each one of these types of information may require a separate information provider. Broadcast radio and television are typically received from over-the-air signals, whereas cable programming is received over conventional cable systems. Internet information is received from a variety of providers.

The multiple information suppliers result in increased costs. These costs include high development costs for the various devices used to receive the information, as well as the infrastructure for producing and delivering the information. Customers also suffer increased costs, as they must purchase multiple receiving devices to interface with the different types of information.

Some systems are able to deliver content to individually identifiable customers. Two examples of this capability include Internet content, which can be directed to the particular Internet address of a user, and cable television systems, which can deliver content to a headend connection that provides programming to a channel selector set-top box at a customer's television set. The content providers, or MSO's, do not typically have a means of determining which users should be which content. Either all users get all of the programming content, or users self-select content, such as through pay-per-view events or requesting and downloading Internet pages.

From the discussion above, it should be apparent that there is a need for a system that can provide content delivery to customers at a simplified delivery model, with reduced costs. The present invention fulfills this need.

### SUMMARY OF THE INVENTION

The present invention provides information from multiple sources to customers, wherein multiple channels of content are received at a service headend connection for customer viewing, information is received from the customer relating to customer viewing, and a selected channel of content likely to be of interest to the customer is determined, based on the received customer viewing information.

In one aspect of the invention, the service headend connection receives programming content from multiple service operators (MSOs) and provides multiple channels of programming content. A client delivery agent at a customer location monitors and collects information relating to customer viewing of content from among the multiple channels of content that are available. The collected customer viewing information is periodically uploaded to the headend connection, where it is accumulated in a database and is analyzed for channels of content likely to be of interest.

In another aspect of the invention, the service headend receives the collected information regarding customer viewing of content, and determines a selected channel of content likely to be of interest to the customer in response to the received information relating to customer viewing. The determination of content likely to be of interest may be performed automatically by the headend unit, through observation, or may be implemented as a combination of automatic observation and customer input of viewing preferences.

In yet another aspect of the invention, the headend includes a service delivery application that uses artificial intelligence techniques to make a determination regarding the programs that might be of interest to the customer.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram that shows the components at the headend location and at the user location.

FIG. 2 is a block diagram that shows components of the headend unit in greater detail, along with the interface to content providers.

FIG. 3 is a block diagram that shows components of the customer system set top box in greater detail.

FIG. 4 is a block diagram representation of one of the computers in the system of FIG. 2.

FIG. 5 is a flow diagram that shows the processing of the user computer illustrated in FIG. 2 to perform content delivery and service delivery agent processing in accordance with the present invention.

FIG. 6 is a flow diagram of the client delivery agent processing in accordance with the present invention.

### DESCRIPTION OF THE PREFERRED EMBODIMENT

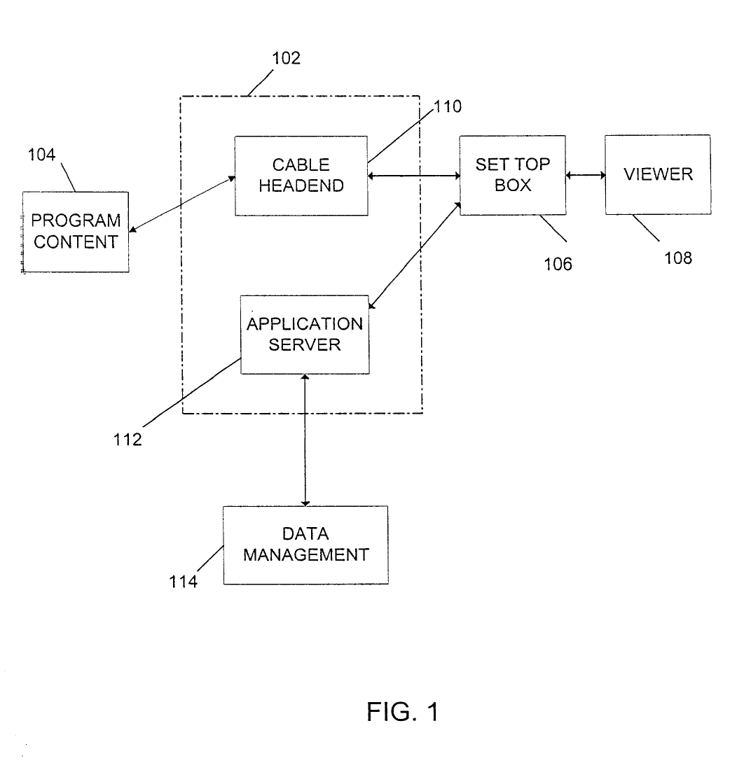

FIG. 1 is a block diagram of a content delivery system 100 constructed in accordance with the present invention. The system includes a headend unit 102 that receives programming content from a variety of content sources 104, including broadcast radio and television, cable services, and Internet service providers. These content providers will be collectively referred to as multidisciplinary service operators (MSOs). The headend unit 102 communicates with a set top box 106, which receives multiple channels of content from the headend connection 102 and then processes the content for viewing by the customer with a viewing device 108. It should be understood that the viewing device may process the content for multimedia presentation, so that “viewing” the content may comprise audio reproduction, visual reproduction, video programming, and any other reproduction of content and processing it into a format that is perceivable by humans. The headend unit processes all information received from the MSOs and processes them for viewing by the viewer. Thus, a single cable headend interface can receive multiple types of signals, including cable television interface, Internet pages, and broadcast radio.

In accordance with the invention, a cable headend connection 110 of the headend unit 102 is connected to programming and content sources 104. A service delivery application 112 of the headend unit receives information relating to customer viewing from the set top box 106, wherein the set top box monitors and collects information relating to customer viewing of content from among the multiple channels of content and provides the information to the service delivery application (SDA) server 112. The SDA server determines a selected channel of content likely to be of interest to the customer in response to the received information relating to customer viewing. In this way, the SDA server can be modified as needed to accommodate new technologies and new or different content sources without the need for providing new devices to pass along the new content to the set top box and can therefore provide such new content at reduced cost. Thus, the system 100 can provide content delivery to customers with a simplified delivery model, with reduced costs.

The system 100 preferably includes a data management unit 114 that receives information about the customer 106 from the SDA server 112. The data management unit 114 can also provide the SDA server with programming information, advertising content, general system information, and the like. The data management unit is preferably independent of the headend unit. Alternatively, the data management functionality can be incorporated into the headend unit, or the headend functionality can be incorporated into the data management unit.

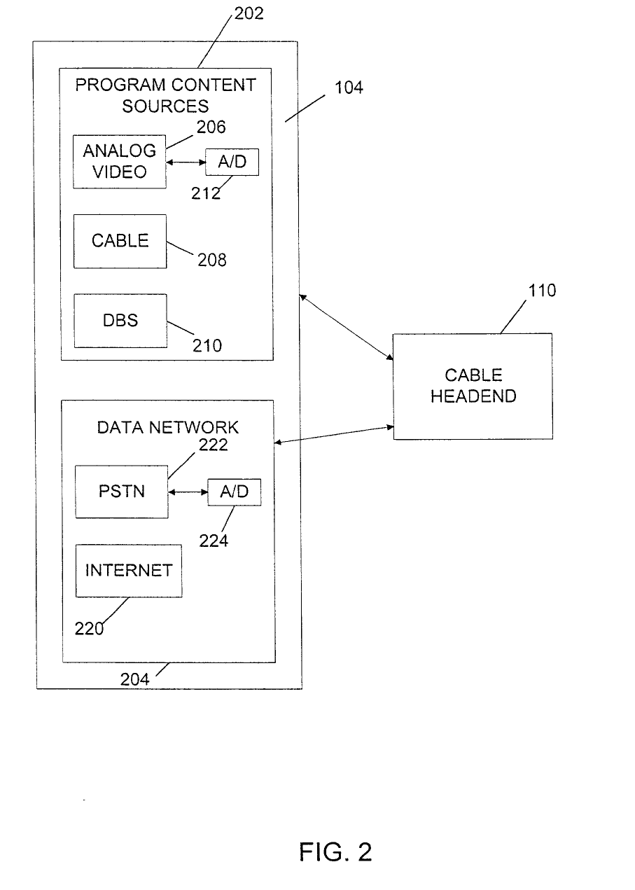

FIG. 2 is a block diagram that shows components of the program content sources 104 received at the cable headend 110 in greater detail. FIG. 2 shows that the preferred embodiment of the cable headend connection 110 receives content signals from multiple sources 104 that may include, for example, program content sources 202 and data network information 204. The program content sources 202 may include analog video signals 206, digital video signals 208, and direct broadcast satellite systems 210. Any analog sources, such as analog video, are converted from analog to digital before transmission to the headend connection using conventional analog-to-digital convertors 212.

FIG. 2 shows that the data networking services 204 provided to the cable headend may include, for example, high speed Internet services 220 such as from a cable television system, or conventional analog sources 222 such as the public switched telephone network (PSTN). If necessary, the data received over the PSTN may be converted from analog information to a digital representation by a conventional A/D convertor 224 prior to delivery to the cable headend 110.

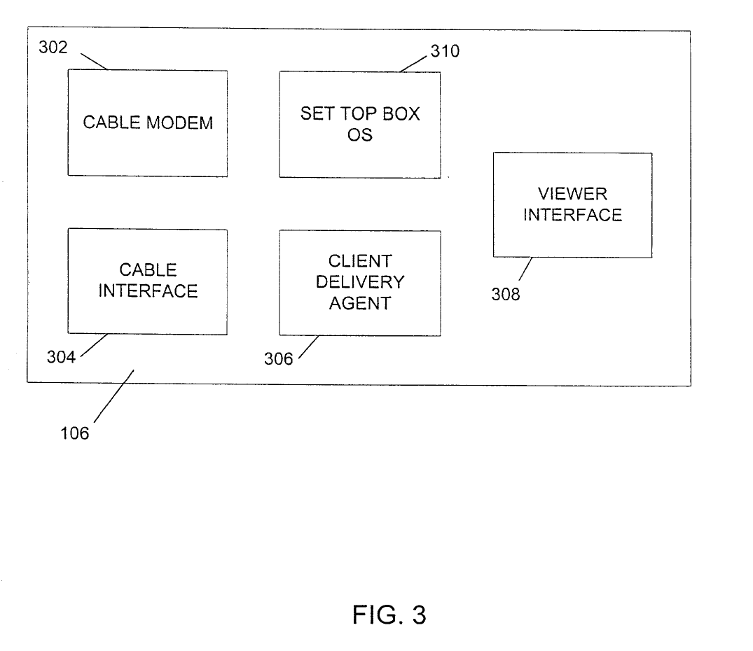

FIG. 3 is a block diagram that shows components of the customer system set top box 106 that receives digital signals from the headend unit 102. The set top box may include a so-called “cable modem” 302 (or may communicate with such a device) to provide an interface to high-speed Internet access provided by a cable television system provider. In addition, the set top box may include a cable interface 304 for video cable signal information, to receive television programming and other cable-originated data for display on the system viewer. As noted above, the viewer may comprise a conventional television monitor, a flat panel display, a Web-enabled device, a computer display screen, or any other communications device with a display or other component that may receive digital information and present it for human reception.

The set top box 106 also includes a client delivery application (CDA) agent 306 that monitors customer viewing, as described further below. The customer can control the information display through a viewer interface 308, which can be incorporated into the CDA agent, if desired. Like the plurality of SDA agents that can be supplemented to handle new devices and technology, the CDA agent and viewer interface can be supplemented or modified to accommodate new technologies and new viewers that may be desired from time to time. As before, this increases flexibility of the system and reduces the cost of development and maintenance of the system 100.

The set top box 106 operates according to a set top box operating system (OS) 310 that may comprise, for example, a conventional set top box OS such as the “PowerTV” OS available from PowerTV, Inc. of Cupertino, Calif., USA, or other commercially available operating systems known to those skilled in the art. Those skilled in the art will understand that such operating systems do not typically have the full pull power and sophistication of computer operating systems such as “Windows 98” or “Windows 2000” by Microsoft Corporation, but are conventionally used for set top box application.

Nevertheless, the operating system for the set top box could, if preferred, comprise a computer operating system such as the personal computer OS alternatives. Other possible operating systems for the set top box 106 may include, for example, the “Palm” operating system from Palm Computing.

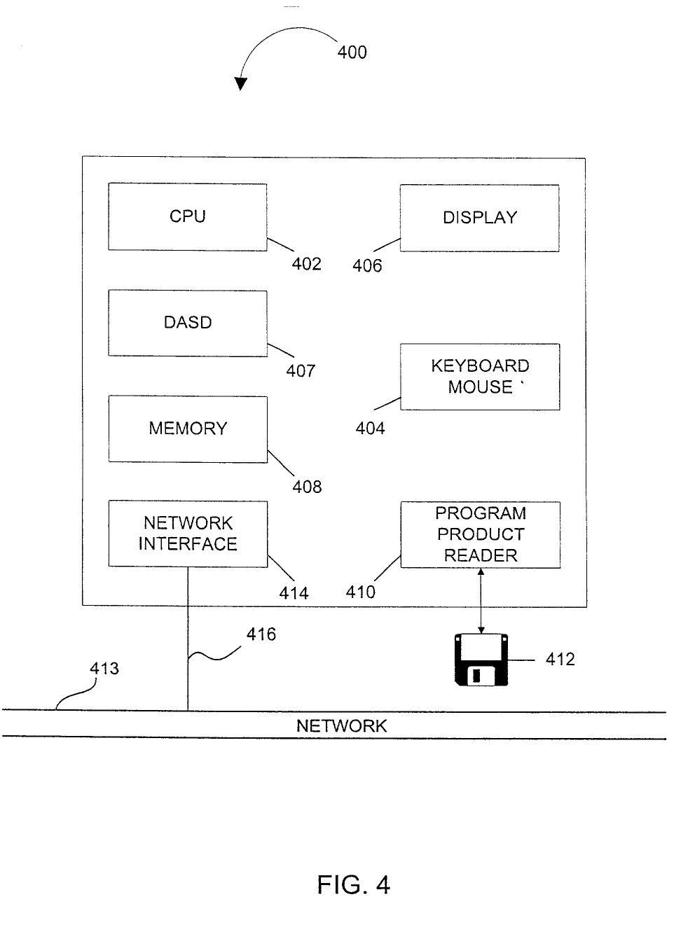

The computer that comprises the application server and data management unit, or any other computer device, may comprise any conventional computer suitable for implementing the functionality described herein. FIG. 4 is a block diagram of an exemplary computer device 400 such as might comprise any of the computing devices shown in FIG. 1. Each computer 400 operates under control of a central processor unit (CPU) 402, such as an application specific integrated circuit (ASIC) from a number of vendors, or a “Pentium”-class microprocessor and associated integrated circuit chips, available from Intel Corporation of Santa Clara, California, USA. Commands and data can be input from a user control panel, remote control device, or a keyboard and mouse combination 404 and inputs and output can be viewed at a display 406. The display is typically a video monitor or flat panel display device.

If the computer device 400 comprises a personal computer, then it preferably includes a direct access storage device (DASD) 407, such as a fixed hard disk drive. The memory 408 typically comprises volatile semiconductor random access memory (RAM) in the case of a personal computer, but in the case of a set top box or other computer device of more modest capability, the memory is likely limited to some form of programmable readonly-memory (PROM). If the computer device 400 is a personal computer, it preferably includes a program product reader 410 that accepts a program product storage device 412, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, DVD disk, or the like. Semiconductor memory devices for data storage may also be used. If the computer device 400 is part of a network, such as a group of computers serving a data management unit function, then each computer 400 can communicate with the other connected computers over a network 413 through a network interface 414 that enables communication over a connection 416 between the network and the computer device.

The CPU 402 operates under control of programming steps that are temporarily stored in the memory 408 of the computer 400. When the programming steps are executed, the pertinent system component performs its functions. Thus, the programming steps implement the functionality of the system illustrated in FIG. 1. The programming steps can be received from the DASD 407, through the program product 412, or through the network connection 416, or can be incorporated into an ASIC as part of the production process. If the computing device includes, a storage drive 410, then it can receive a program product, read programming steps recorded thereon, and transfer the programming steps into the memory 408 for execution by the CPU 402. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 408 over the network 413. In the network method, the computer receives data including program steps into the memory 408 through the network interface 414 after network communication has been established over the network connection 416 by well-known methods that will be understood by those skilled in the art without further explanation. The program steps are then executed by the CPU 402 to implement the processing of the e-mail message tracking system.

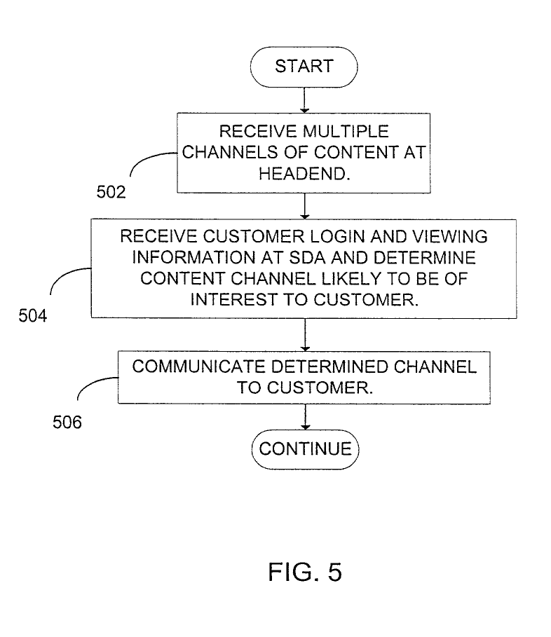

FIG. 5 is a flow diagram that shows the processing of the SDA computer illustrated in FIG. 2 to perform content delivery and service delivery agent processing in accordance with the present invention. In the first processing operation, indicated by the flow diagram box numbered 502, the SDA receives multiple channels of content at the headend unit. These may comprise, for example, a combination of cable television programming, Internet access, directed advertising, or other proprietary programming content.

At the next operation of the flow diagram box numbered 504, the SDA receives customer login and viewing information, and determines a content channel likely to be of interest to the customer. The login information will typically identify one or more users who are viewing the display at the set top box. As described further below, the content channel determination may be based on the login user's past viewing habits or response to surveys or questions, which data may be received by the CDA. For a set top box in a residence, the determined content channel may include suggested cable programming of shows that coincide with viewing patterns. If the viewing device comprises a display unit at a commercial establishment, such as a hotel lobby or public area, for example, then there may be no customer login for passersby, but rather an initial login for the hosting business. Alternatively, customer identification information may comprise a request or query for information from the system. In that case, the determined content channel will likely comprise information about local attractions or special promotions available from area business establishments.

The next operation involves the suggestion being communicated to the customer. This may occur in response to a customer prompt, or it may automatically occur during normal viewing. This operation is represented by the flow diagram box numbered 506. The other end of processing in the system occurs at the set top box.

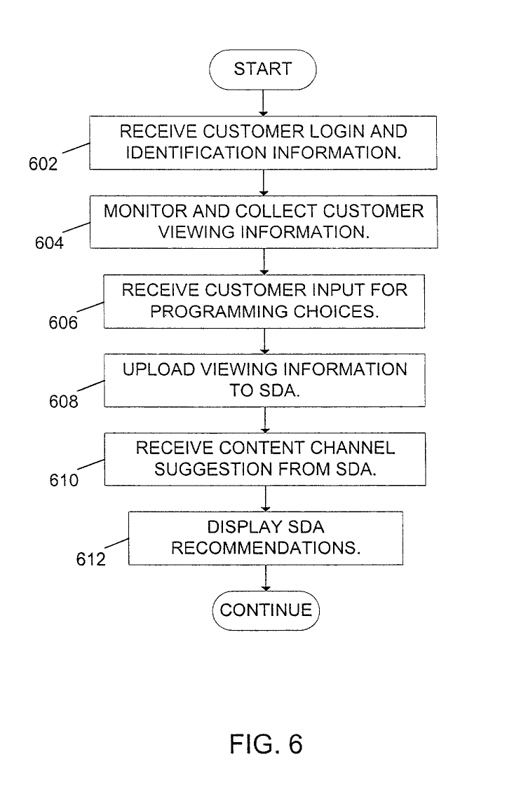

FIG. 6 is a flow diagram of the client delivery agent (CDA) processing at the set top box in accordance with the present invention. In the first processing operation, represented by the flow diagram box numbered 602, the CDA receives customer login information and identification of the customer. In the case of a typical residential customer, the information comprises the one or more family members who will be watching the display. The system preferably associates previously collected viewing information for each one of the gathered family members upon receiving the customer identification information. In the case of a business establishment that hosts the set top box and provides for viewing of the display viewer, the information will likely comprise login information relating to the hosting business, to initiate processing, rather than end users for whom programming content is intended.

In the next operation, represented by box 604, the CDA monitors and collects customer viewing information. For a residential customer, this may comprise automatic collection of program viewing habits for the identified family members who are watching. For set top boxes or other devices located in a business establishment, the information may comprise requests or queries for information. At the next operation, the CDA receives customer input for programming choices, indicated by the flow diagram box numbered 606. The programming choices may comprise channel selections for viewing broadcast cable, for example. Alternatively, the choices may comprise requests from business establishment customers for specific information relating to particular subject matters or locations. For example, customers may be interested in particular local attractions, or restaurant types, or shopping centers. This information is received and collected by the CDA in the operation 606. Some of the customer input from the set top box at 606 may require immediate action, such as channel selection at a television monitoring device or a request for local information. Other customer input may require less urgent processing, such as information that a residential viewer is still observing the same programming content (channel) as reported at a prior data interval. The CDA automatically determines urgent data that must be communicated to another component immediately and other data that can be communicated at a later time.

At the next operation 608, the system uploads collected viewing information to the SDA. This information comprises information that was not urgently required for immediate processing, such as described above. The time interval of sending non-urgent, collected lid viewing information to the SDA for processing will depend on system requirements and the available resources. Thus, the time interval may depend on the data storage capacity of the set top box and the communication speed of the connection between the set top box and the SDA.

The CDA receives the content channel suggestions from the SDA at the flow diagram box numbered 610. The processing carried out at the SDA to produce the suggestion may be implemented with conventional artificial intelligence techniques, using the computing power of the SDA computer and any information obtained from the data management unit.

Next, at the box numbered 612, the suggestion from the SDA is displayed at the customer display device. As noted above, the display device may comprise a conventional television display associated with the set top box, or may comprise a computer monitor for a personal computer associated with the set top box, or may comprise a display for a wireless device that is associated with the set top box or other component providing the same functionality. Other system operation then continues.

The present invention has been described above in terms of a presently preferred embodiment so that an understanding of the present invention can be conveyed. There are, however, many configurations for content delivery systems not specifically described herein but with which the present invention is applicable. The present invention should therefore not be seen as limited to the particular embodiments described herein, but rather, it should be understood that the present invention has wide applicability with respect to content delivery systems generally. All modifications, variations, or equivalent arrangements and implementations that are within the scope of the attached claims should therefore be considered within the scope of the invention.

We claim:

1. A computer method of content delivery to a customer, the method comprising:
receiving multiple channels of content at a service headend connection for customer viewing;
receiving information from the customer relating to customer viewing;
determining a selected one of the channels of content likely to be of interest to the customer, based on the received information; and
providing the selected content.

2. A method as defined in claim 1, wherein the channels of content include television broadcast channels.

3. A method as defined in claim 1, wherein the channels of content include Internet services.

4. A method as defined in claim 1, wherein the customer comprises one or more individuals, and wherein receiving information from the customer comprises receiving information regarding each of the individuals.

5. A method as defined in claim 4, wherein receiving information from the customer includes receiving information regarding viewing patterns of the one or more individuals with respect to the multiple channels of content.

6. A method as defined in claim 5, additionally comprising associating a viewing pattern with a particular individual.

7. A method as defined in claim 1, wherein the customer comprises a business entity, and wherein receiving information from the customer comprises receiving information regarding the type of business entity.

8. A method as defined in claim 7, wherein receiving information from the customer comprises receiving information regarding the location of the business entity.

9. A system of providing content delivery to a customer, the system comprising:
a client delivery application that monitors and collects information relating to customer viewing of content from among multiple channels of content; and
a network connection at the client delivery application to a service headend that provides the multiple channels of content, wherein the service headend receives the information regarding customer viewing of content, and includes a service delivery application that determines a selected channel of content likely to be of interest to the customer in response to the received information relating to customer viewing.

10. A system as defined in claim 9, wherein the customer comprises one or more individuals, and wherein the information relating to customer viewing of content includes viewing habits of the one or more individuals.

11. A system as defined in claim 10, wherein the client delivery application associates the information relating to customer viewing with one of the one or more individuals.

12. A system as defined in claim 9, wherein the customer comprises a business establishment, and wherein the client delivery application provides a query for the customer to provide information related to customer viewing of content from among multiple channels of content.

13. A system as defined in claim 12, wherein the selected channel of content likely to be of interest to the user includes information related to the location of the business establishment.

14. A system that provides information content delivery to a customer, the system comprising:
a service headend that provides multiple channels of information content for viewing by the customer; and
a service delivery application executing on a receiving device that receives information relating to customer viewing from a client delivery application, wherein the service delivery application executes on the receiving device to monitor and collect information relating to customer viewing of content from among the multiple channels of information content, and the service delivery application determines a selected channel of content likely to be of interest to the customer in response to the received information relating to customer viewing.

15. A system as defined in claim 14, wherein the customer comprises one or more individuals, and wherein the information relating to customer viewing relates to viewing habits of the one or more individuals.

16. A system as defined in claim 15, wherein the service delivery application associates a viewing habit with one of the one or more individuals.

17. A system as defined in claim 14, wherein the multiple channels of information content include television broadcast channels.

18. A system as defined in claim 14, wherein the multiple channels of information content include Internet channels.

19. A system that delivers content to a customer, the system comprising one or more processors that execute program instructions and receive a data set, wherein the program instructions are executed to cause the processor to:
receive multiple channels of content at a service headend connection for customer viewing;
receive information from the customer relating to customer viewing;
determine a selected one of the channels of content likely to be of interest to the customer, based on the received information and providing the selected content.

20. A program product for use in a computer system that executes program steps recorded in a computer-readable media to perform a method for delivering content to a customer, the program product comprising:
a recordable media;
a program of computer-readable instructions executable by the computer system to perform operations comprising:
receiving multiple channels of content at a service headend connection for customer viewing; receiving information from the customer relating to customer viewing; determining a selected one of the channels of content likely to be of interest to the customer, based on the received information; and providing the selected content.
